(19) United States
(12) Patent Application Publication
(10) Pub. No.: US 2021/0136245 A1
(43) Pub. Date: May 6, 2021

(54) INFORMATION PROCESSING DEVICE, AND INFORMATION PROCESSING SYSTEM

(71) Applicant: FUJI XEROX CO., LTD., Tokyo (JP)

(72) Inventors: Hajime KAJIYAMA, Kanagawa (JP); Taku YOSHIMURA, Kanagawa (JP); Hiromi ICHIBA, Kanagawa (JP); Ryoji MATSUMURA, Kanagawa (JP); Yu OHTAKE, Kanagawa (JP); Kazumoto SHINODA, Kanagawa (JP)

(73) Assignee: FUJI XEROX CO., LTD., Tokyo (JP)

(21) Appl. No.: 16/896,662

(22) Filed: Jun. 9, 2020

(30) Foreign Application Priority Data
Oct. 30, 2019 (JP) 2019-197056

(51) Int. Cl. H04N 1/00

(52) U.S. Cl. CPC H04N 1/00973; H04N 1/00244

(57) ABSTRACT

An information processing device includes a processor configured to acquire setting information from image data obtained by reading an image relating to the setting information that is output from an image forming device.

### CROSS-REFERENCE TO RELATED APPLICATIONS

This application is based on and claims priority under 35 USC 119 from Japanese Patent Application No. 2019-197056 filed Oct. 30, 2019.

### BACKGROUND

### (i) Technical Field

The present disclosure relates to an information processing device and an information processing system.

### (ii) Related Art

It is known for setting information that has been set in an image forming device to be exported, in other words backed up, to a cloud server connected to the image forming device via a network, or to a computer terminal device connected to the image forming device, and for the backed-up setting information to be transferred from the cloud server or the computer terminal device to another image forming device.

### SUMMARY

However, some image forming devices do not have a function to transmit setting information outside of the device or a function to connect to a network to begin with. Furthermore, even if there is a transmission function, in some cases the transmission function itself is faulty. Furthermore, there are also image forming devices to which it is not possible to connect an external storage device for outputting and saving setting information, such as a USB memory. In addition, there are also image forming devices that are not able to read their own IP addresses in order to communicate with other image forming devices.

Aspects of non-limiting embodiments of the present disclosure relate to making it possible for setting information of an image forming device to be backed up using an image forming function of the image forming device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to acquire setting information from image data obtained by reading an image relating to the setting information that is output from an image forming device.

### BRIEF DESCRIPTION OF THE DRAWINGS

An exemplary embodiment of the present disclosure will be described in detail based on the following figures, wherein:

FIG. 1 is an overall schematic view of a backup/transfer system in one exemplary embodiment of the present disclosure;

FIG. 2A is a drawing depicting a hardware configuration of a cloud server of the exemplary embodiment, and FIG. 2B is a functional block diagram of the cloud server;

FIG. 3A is a drawing depicting a hardware configuration of a multifunction device of the exemplary embodiment, and FIG. 3B is a functional block diagram of the multifunction device;

FIG. 4A is a flowchart depicting the flow of backup processing for setting information of a first multifunction device performed in a second multifunction device, and FIG. 4B is a flowchart depicting the flow of transfer processing for setting information of the first multifunction device performed in the cloud server;

FIG. 5A is a drawing depicting an example of a setting information image, and FIG. 5B is a drawing depicting an example of setting information converted from setting information image data obtained by reading the setting information image of FIG. 5A;

FIG. 6 is an overall schematic view of a backup/transfer system of modified example 1;

FIG. 7 is an overall schematic view of a backup/transfer system of modified example 2; and

FIG. 8 is an overall schematic view of a backup/transfer system of modified example 3.

### DETAILED DESCRIPTION

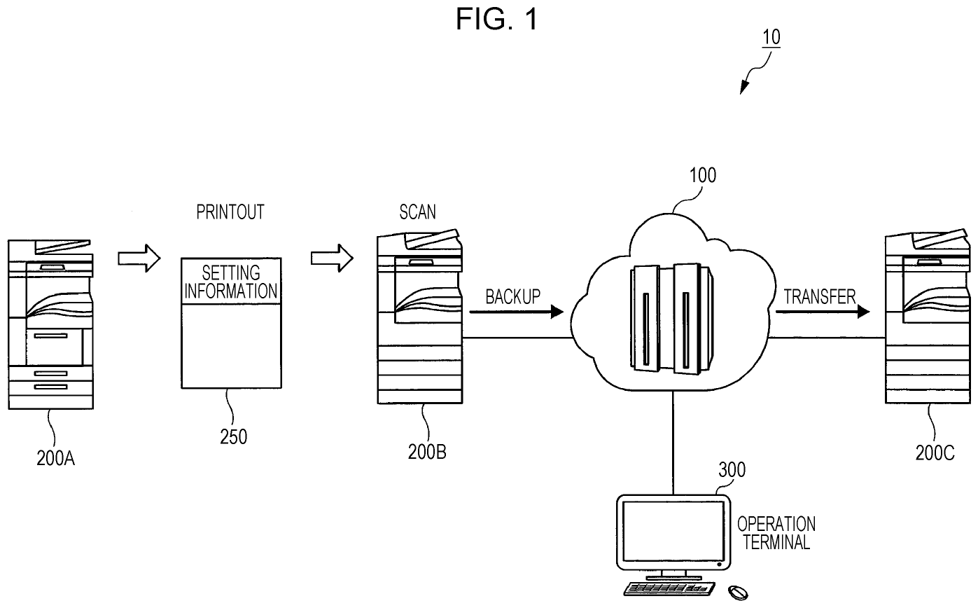

A backup/transfer system 10 for setting information in one exemplary embodiment of the present disclosure will be described with reference to FIG. 1. It should be noted that FIG. 1 is an overall schematic view of the backup/transfer system 10 for setting information in one exemplary embodiment of the present disclosure. The backup/transfer system 10 for setting information is provided with: a cloud server 100; a first multifunction device 200A that is not connected or cannot be connected to the cloud server 100 via a network; a second multifunction device 200B that is connected to the cloud server 100 via the network; a third multifunction device 200C that is connected to the cloud server 100 via the network; and an operation terminal 300 for operating the cloud server 100.

In this backup/transfer system 10 for setting information, there are cases where it is desired for setting information of the first multifunction device 200A to be transferred to and used by the third multifunction device 200C. For example, in an office in which a multifunction device is installed, there are cases where it becomes necessary for an old model such as the first multifunction device 200A to be replaced with a newer model such as the third multifunction device 200C. However, in a case where the first multifunction device 200A does not have a network connection function, or in a case where the first multifunction device 200A has a network connection function but it is faulty and cannot be used, it is not possible or it may be difficult for the setting information of the first multifunction device 200A to be transferred to the third multifunction device 200C.

In the present exemplary embodiment, the setting information of the first multifunction device 200A is printed onto a paper surface as a setting information image 250. This setting information image 250 printed onto a paper surface may be produced by writing setting information in a list format using characters, as depicted in FIG. 1, or may be produced by printing setting information that has been converted into a two-dimensional code so as to be unreadable by a person even if seen.

The printed setting information image 250 is read as setting information image data by a scanning device of the second multifunction device 200B that is connected to the cloud server 100 via the network, and the setting information image data is analyzed and converted into setting information in the second multifunction device 200B, or is not analyzed, and is backed up to the cloud server 100. In a case where the setting information image data is not analyzed by the second multifunction device 200B, the setting information image data is analyzed in the cloud server 100 and is converted into setting information and stored.

The cloud server 100 of the present exemplary embodiment provides a web interface to the operation terminal 300 by activating an installed application program. A device administrator operates the web interface displayed on a display device of the operation terminal 300, thereby causing the cloud server 100 to acquire setting information of the first multifunction device 200A from the second multifunction device 200B and to back up the setting information. In addition, on the basis of an operation that is input from the web interface displayed on the operation terminal 300, the cloud server 100 transfers the setting information backed up to the cloud server 100, to the third multifunction device 200C which is a transfer destination. It should be noted that the cloud server 100 may be a physical server.

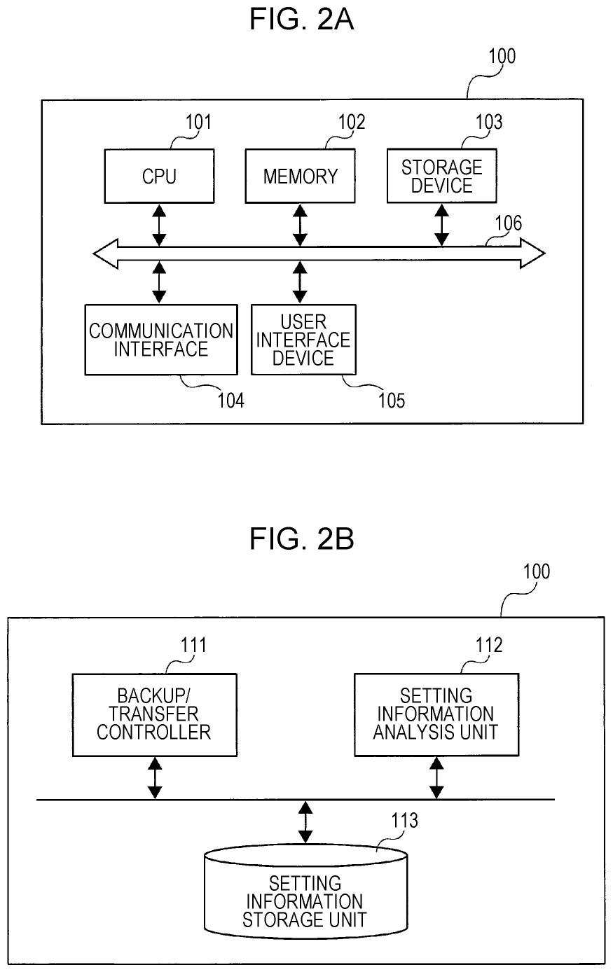

The cloud server 100 of the present exemplary embodiment will be described with reference to FIG. 2. It should be noted that FIG. 2A is a drawing depicting a hardware configuration of the cloud server 100 of the present exemplary embodiment, and FIG. 2B is a functional block diagram of the cloud server 100.

As depicted in FIG. 2A, the cloud server 100 has a CPU 101, a memory 102, a storage device 103, a communication interface 104, and a user interface device 105, each of which is connected to a control bus 106.

The CPU 101 is a virtual central processing unit or a virtual processor of the cloud server 100, and controls the operation of each unit of the cloud server 100 on the basis of a control program stored in the storage device 103.

The memory 102 has temporarily stored therein setting information and setting information image data acquired from the second multifunction device 200B, and setting information to be transferred that is acquired from the storage device 103.

The storage device 103 is constituted by a hard disk drive (abbreviated as HDD) or a solid-state drive (abbreviated as SSD), and a control program for controlling each unit of the cloud server 100 is stored therein. Furthermore, setting information that is backed up from the second multifunction device 200B is stored in the storage device 103.

The communication interface 104 carries out communication between the cloud server 100 and the second multifunction device 200B, third multifunction device 200C, and operation terminal 300, and carries out communication control for acquiring and transmitting setting information.

The user interface device 105 is constituted by a liquid crystal display and a keyboard connected to the cloud server 100.

As depicted in FIG. 2B, the cloud server 100 performs the functions of a backup/transfer controller 111, a setting information analysis unit 112, and a setting information storage unit 113 by the control program stored in the storage device 103 being executed in the CPU 101.

The backup/transfer controller 111, for example, acquires setting information of the first multifunction device 200A that has been read and analyzed in the second multifunction device 200B and backs up the setting information to the setting information storage unit 113, or acquires setting information image data that has been read in the second multifunction device 200B and stores the setting information image data in the memory 102, and transfers the backed up setting information stored in the setting information storage unit 113 to the third multifunction device 200C, in accordance with instructions input via the operation terminal 300.

The setting information analysis unit 112 determines whether or not information received from the second multifunction device 200B is data that has been analyzed, in other words whether the received information is setting information image data or analyzed setting information. Furthermore, in a case where the received information is not data that has been analyzed, is setting information image data in other words, the setting information analysis unit 112 analyzes and converts the received setting information image data into setting information.

The setting information storage unit 113 stores setting information that has been backed up from the second multifunction device 200B. Furthermore, in a case where the cloud server 100 is connected to other multifunction devices via the network, the setting information storage unit 113 stores setting information that has been backed up from the other multifunction devices.

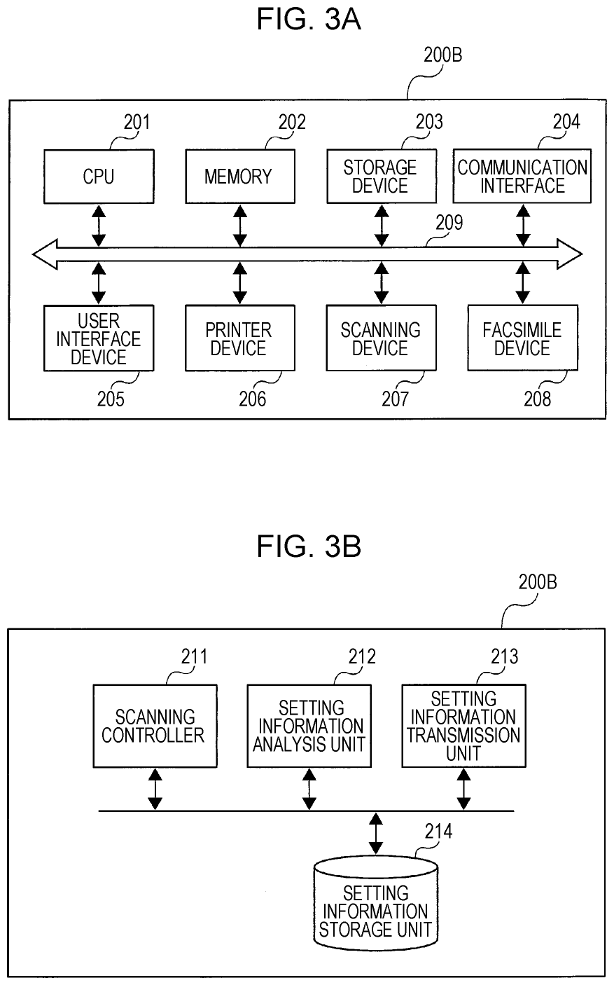

Next, the second multifunction device 200B which reads a setting information image printed from the first multifunction device 200A will be described with reference to FIGS. 3A and 3B. It should be noted that FIG. 3A is a drawing depicting a hardware configuration of the multifunction device 200B of the exemplary embodiment, and FIG. 3B is a functional block diagram of the multifunction device 200B.

The multifunction device 200B has a CPU 201, a memory 202, a storage device 203, a communication interface 204, a user interface device 205, a printer device 206, a scanning device 207, and a facsimile device 208, which are each connected to a control bus 209.

The CPU 201 is a control microprocessor and controls the operation of each unit of the second multifunction device 200B on the basis of a control program stored in the storage device 203.

The memory 202 temporarily stores image data and scanned image data to be printed by the second multifunction device 200B. Furthermore, the memory 202 temporarily stores setting information and setting information transfer instructions received from the cloud server 100.

The storage device 203 is constituted by a hard disk drive (abbreviated as HDD) or a solid-state drive (abbreviated as SSD), and a control program for controlling each unit of the second multifunction device 200B is stored therein. Furthermore, setting information of the second multifunction device 200B itself is stored in the storage device 203.

The communication interface 204 carries out communication between the second multifunction device 200B and the cloud server 100, and carries out communication control for transmitting setting information.

The user interface device 205 is constituted by a liquid crystal display and a touch panel provided in the multifunction device 200B and displays various types of screens on the liquid crystal display, and is able to receive operations and input information by a user or the device administrator operating the touch panel.

The printer device 206 prints, onto a paper surface, images transmitted from an undepicted computer terminal connected to the multifunction device 200B via the network. The scanning device 207 reads in image data from a document placed on a document holder, stores the image data in the memory 202, and transmits the image data to an undepicted computer terminal connected to the multifunction device 200B via the network. The facsimile device 208 transmits, to another multifunction device or facsimile device via a telephone line, image data read in by the scanning device 207 and stored in the memory 202, or image data transmitted from an undepicted computer terminal and stored in the memory 202.

As depicted in FIG. 3B, the second multifunction device 200B performs the functions of a scanning controller 211, a setting information analysis unit 212, a setting information transmission unit 213, and a setting information storage unit 214, by the control program stored in the storage device 203 being executed in the CPU 201.

The scanning controller 211 drives the scanning device 207 of the second multifunction device 200B, and stores data that has been read in the memory 202 as image data. In particular, in a case where a setting information image is scanned, the scanning controller 211 stores setting information image data in the memory 202.

The setting information analysis unit 212 analyzes and converts setting information image data stored in the memory 202 into setting information.

The setting information transmission unit 213 transmits setting information stored in the memory 202 to the cloud server 100 in accordance with an instruction from the cloud server 100 or an instruction produced by the user interface device 205 of the second multifunction device 200B being operated.

The setting information storage unit 214 stores setting information of the second multifunction device 200B itself.

The operation terminal 300 is a personal computer or a tablet computer terminal connected to the cloud server 100 via the network, and is provided with a memory and a control processor that controls the operation of each unit, and a user interface device including a display device such as a liquid crystal display and input devices such as a keyboard and mouse or a touch panel. This operation terminal 300 merely functions as a user interface for the cloud server 100, which displays the web user interface provided by the cloud server 100 and carries out input operations, and therefore a detailed description thereof is omitted.

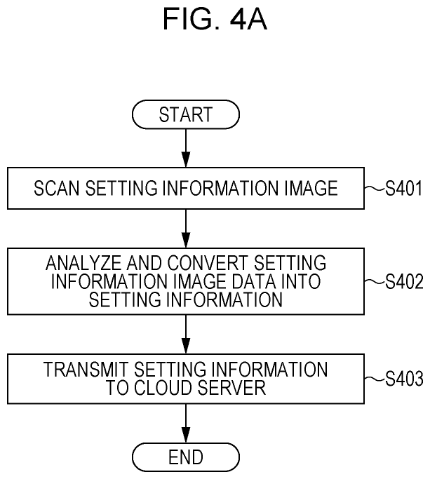

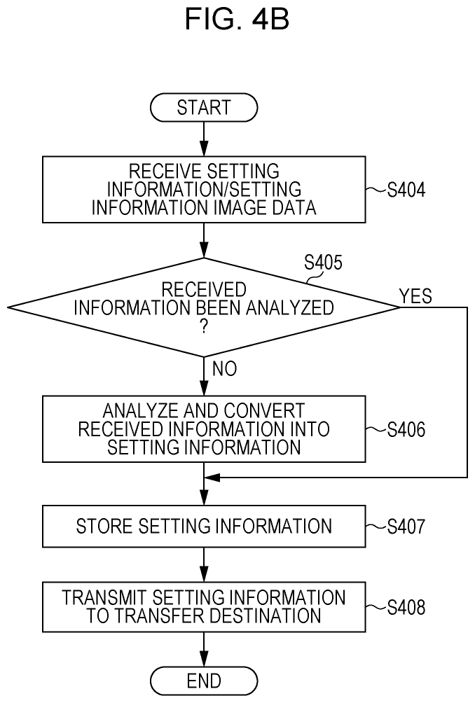

Next, backup/transfer processing for setting information of the first multifunction device 200A performed in the second multifunction device 200B and the cloud server 100 will be described with reference to FIGS. 4A and 4B. It should be noted that FIG. 4A is a flowchart depicting the flow of backup processing for setting information of the first multifunction device 200A performed in the second multifunction device 200B, and FIG. 4B is a flowchart depicting the flow of transfer processing for setting information of the first multifunction device 200A performed in the cloud server 100.

First, prior to the processing in the second multifunction device 200B, the device administrator operates the first multifunction device 200A for setting information of the first multifunction device to be output, in other words printed, onto a paper surface as an image relating to the setting information, namely the setting information image 250. The setting information image 250 output from the first multifunction device 200A may be produced by listing actual setting information in a list format as characters, as illustrated in FIG. 1, or may be produced by having been converted into a format such as a two-dimensional code so as to not be read by a person even if seen.

In step 5401 of FIG. 4A, the scanning controller 211 of the second multifunction device 200B drives the scanning device 207, reads a setting information image of the first multifunction device 200A that has been printed, and temporarily stores the setting information image in the memory 202 as setting information image data.

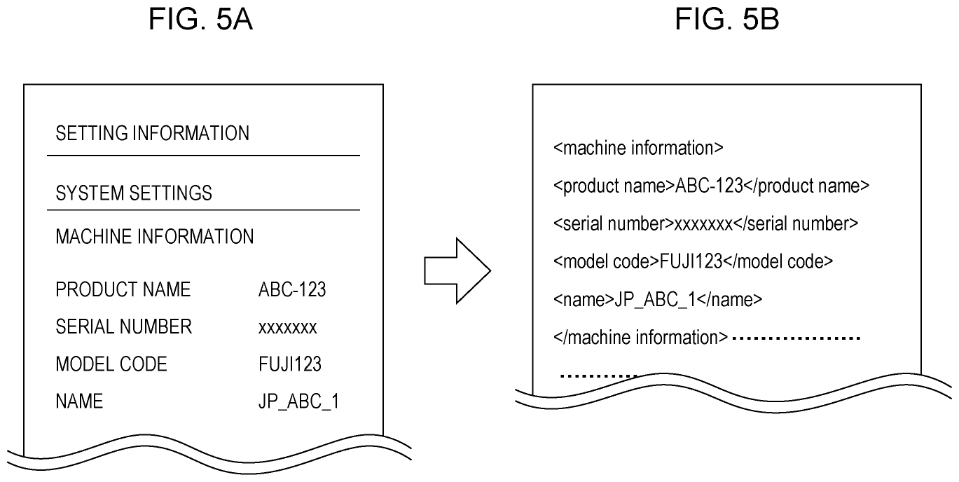

In step S402, the setting information analysis unit 212 analyzes and converts the setting information image data that is read in step S401 and stored in the memory 202, into setting information, and temporarily stores the setting information in the memory 202. Here, a method with which the setting information analysis unit 212 converts setting information image data into setting information will be described with reference to FIG. 5. It should be noted that FIGS. 5A and 5B are illustrations depicting an example of conversion processing in which the setting information analysis unit 212 analyzes and converts setting information image data into setting information, FIG. 5A being a drawing depicting an example of a setting information image, and FIG. 5B being a drawing depicting an example of setting information converted from setting information image data obtained by reading the setting information image of FIG. 5A.

As depicted in FIG. 5A, a setting information image has setting information written in a list format using characters, and includes setting items such as system settings and firmware settings, with each setting item being constituted by multiple items of individual setting data.

The setting information analysis unit 112 converts setting information image data obtained by reading the setting information image depicted in FIG. 5A, into character data using an optical character recognition function (abbreviated as an OCR function), and, based on the list-format character data, converts the character data into a data format with which data can be exchanged among different devices, such as an XML format as depicted in FIG. 5B, and stores the converted data in the memory 202. As depicted in FIG. 5B, the setting information is written such that the respective setting items and setting data names included in the setting items are represented as tags and setting values are enclosed between the respective tags. The present exemplary embodiment describes a case where setting information is written in an XML format; however, it should be noted that the present disclosure is not restricted to this example, and the setting information may be written in a CSV format or a JSON format.

In step S403 of FIG. 4, the setting information transmission unit 213 transmits the setting information of the first multifunction device 200A that has been analyzed and converted as mentioned above to the cloud server 100, and the processing in the second multifunction device 200B ends. It should be noted that this transmission processing may be executed according to an instruction from the cloud server 100 generated by the device administrator operating the operation terminal 300, or may be executed according to an instruction that is input by the device administrator operating the user interface device 205 of the second multifunction device 200B.

Hereinafter, the processing of FIG. 4B is processing that is performed in the cloud server 100. In step S404 of FIG. 4B, the backup/transfer controller 111 of the cloud server 100 receives setting information of the first multifunction device 200A or unanalyzed setting information image data from the second multifunction device 200B, and temporarily stores the setting information or the setting information image data in the memory 102.

In step S405, the setting information analysis unit 112 of the cloud server 100 determines whether or not the information received from the second multifunction device 200B is data that has been analyzed, in other words, determines whether or not the received information is setting information that has been analyzed. If it is determined that the information received from the second multifunction device 200B has not been analyzed, processing proceeds to step S406, whereas if it is determined that the information has been analyzed, processing proceeds to step S407.

If the information received from the second multifunction device 200B has not been analyzed, in step S406, the setting information analysis unit 112 of the cloud server 100 analyzes and converts the received setting information image data into setting information. Specifically, as illustrated in FIG. 5, image data is converted into character information using an optical character recognition function (abbreviated as an OCR function), and, based on setting information of the character information which is in a list format, a conversion is performed into setting information of a format that can be handled by a computer such as an XML format.

In step S407, setting information of the first multifunction device 200A that has already been analyzed in the second multifunction device 200B or in the cloud server 100 is stored in the setting information storage unit 214, and the backup processing is completed.

Next, the device administrator operates the operation terminal 300 to thereby select which setting items are to be transferred to the third multifunction device 200C out of the setting information of the first multifunction device 200A backed up to the cloud server 100, and instructs transfer processing to be executed.

According to this transfer instruction, in step 5408, the backup/transfer controller 111 of the cloud server 100 transmits the setting information of the first multifunction device 200A stored in the setting information storage unit 113 to the third multifunction device 200C which is the transfer destination, and the processing in the cloud server 100 ends. It should be noted that the third multifunction device 200C, upon receiving the setting information from the cloud server 100, resets this setting information as the setting information of the third multifunction device 200C, and the transfer processing ends.

### Modified Example 1

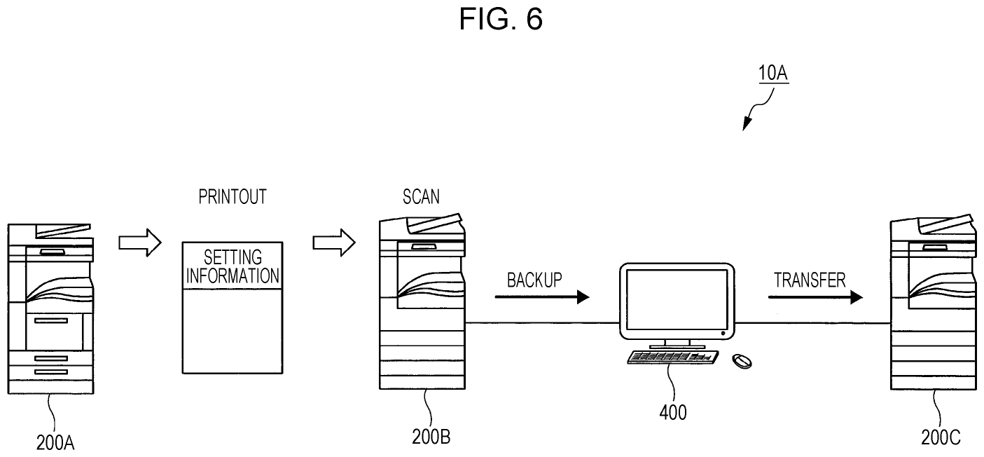

Next, a backup/transfer system 10A of modified example 1 will be described with reference to FIG. 6. It should be noted that FIG. 6 is an overall schematic view of the backup/transfer system 10A of modified example 1. In modified example 1, the cloud server 100 and the operation terminal 300 in the aforementioned exemplary embodiment are replaced with a computer 400 in which application software for transferring setting information is installed. The second multifunction device 200B and the third multifunction device 200C are each connected to the computer 400. When the aforementioned exemplary embodiment and modified example 1 are compared, modified example 1 is the same as the aforementioned exemplary embodiment regarding the configuration other than the computer 400, and therefore the description hereinafter will be given using the same reference numerals.

In the backup/transfer system 10A of modified example 1, similar to the aforementioned exemplary embodiment, setting information of the first multifunction device 200A is printed on a paper surface as a setting information image, and the printed setting information image is read as setting information image data by the scanning device of the second multifunction device 200B, and is transmitted to the computer 400 having been analyzed in the second multifunction device 200B or without having been analyzed.

The computer 400, upon receiving the setting information of the first multifunction device 200A or the unanalyzed setting information image data from the second multifunction device 200B, determines whether or not the information received from the second multifunction device 200B is data that has been analyzed, and, if having determined that the received information has not been analyzed, analyzes and converts the received setting information image data into setting information, and stores the setting information.

In addition, the computer 400 receives edits for the stored setting information. Edit processing includes converting into a different data format that can be handled by the third multifunction device 200C, and changing the setting values of individual setting data included in respective setting items, in a case where the third multifunction device 200C to which the transfer is to be performed uses a data format that is different from that of the setting information of the second multifunction device 200B, for example.

After having edited the setting information, the device administrator operates a user interface device of the computer 400, selects which setting items are to be transferred to the third multifunction device 200C out of the setting information stored in the computer 400, and transmits the edited setting information of the first multifunction device 200A corresponding to the setting items in question to the third multifunction device 200C which is the transfer destination, and the processing in the computer 400 ends. It should be noted that the third multifunction device 200C, upon receiving the setting information from the computer 400, sets this setting information as setting information of the third multifunction device 200C, and the transfer processing ends.

### Modified Example 2

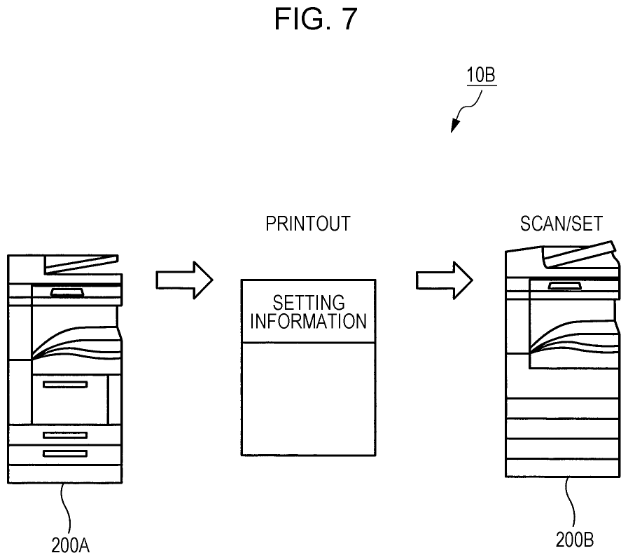

Next, a backup/transfer system 10B of modified example 2 will be described with reference to FIG. 7. It should be noted that FIG. 7 is an overall schematic view of the backup/transfer system 10B of modified example 2. In modified example 2, the backup/transfer system 10B is configured of only the first multifunction device 200A and the second multifunction device 200B similar to the aforementioned exemplary embodiment. Consequently, the description hereinafter will be given using the same reference numerals for constituent elements that are the same as in the aforementioned exemplary embodiment.

In the backup/transfer system 10B of modified example 2, similar to the aforementioned exemplary embodiment, setting information of the first multifunction device 200A is printed on a paper surface as the setting information image 250, and the printed setting information image 250 is read as setting information image data by the scanning device of the second multifunction device 200B. Next, the setting information image data that has been read is analyzed and converted into setting information in the second multifunction device 200B, and the converted setting information is set as it is as new setting information of the 2nd multifunction device 200B.

Consequently, in the backup/transfer system 10B of modified example 2, the setting information of the first multifunction device 200A is transferred to the second multifunction device 200B. It should be noted that the setting information analyzed in the second multifunction device 200B may be backed up to the cloud server 100 in a case where the cloud server 100 or the like is connected to the second multifunction device 200B.

### Modified Example 3

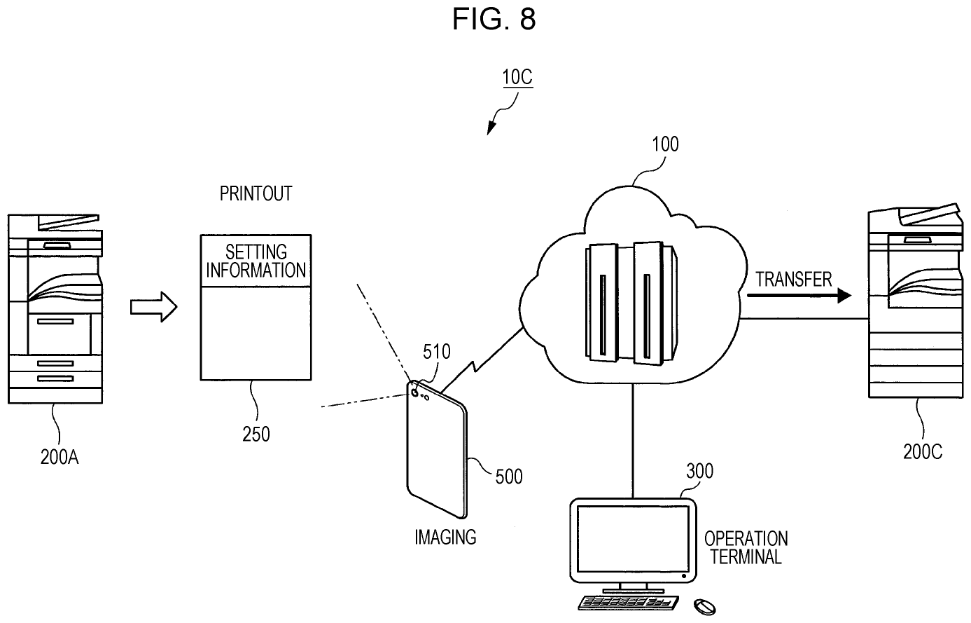

Next, a backup/transfer system 10C of modified example 3 will be described with reference to FIG. 8. It should be noted that FIG. 8 is an overall schematic view of the backup/transfer system 10C of modified example 3. In modified example 3, the second multifunction device 200B in the aforementioned exemplary embodiment is replaced with a smartphone 500 provided with a camera device 510. Consequently, the description hereinafter will be given using the same reference numerals for constituent elements that are the same as in the aforementioned exemplary embodiment, apart from the smartphone 500.

In the backup/transfer system 10C of modified example 3, first, similar to the aforementioned exemplary embodiment, setting information of the first multifunction device 200A is printed on a paper surface as the setting information image 250. Next, the printed setting information image 250 is captured by the camera device 510 of the smartphone 500 and stored as setting information image data. In addition, this setting information image data is transmitted to the cloud server 100 using a communication function of the smartphone 500.

The cloud server 100 analyzes and converts the setting information image data received from the smartphone 500 into setting information, and transmits the setting information to the third multifunction device 200C which is the transfer destination, in accordance with an instruction from the device administrator. The multifunction device 200C, upon receiving the setting information from the cloud server 100, sets this setting information as setting information of the multifunction device 200C, and the transfer processing ends.

In the aforementioned exemplary embodiment and modified examples 1 to 3, the case where the first multifunction device 200A is a multifunction device has been described as an example; however, it should be noted that the present disclosure is not restricted thereto, and a printer device having only an image forming function may be adopted.

In addition, in the aforementioned exemplary embodiment and modified examples 1 to 3, an example has been described in which the setting information image 250 is printed on a paper surface using an image forming function of the first multifunction device 200A; however, the present disclosure is not restricted thereto, and in a case where the first multifunction device 200A is provided with a display device, the setting information image 250 may be shown on the display device, and this may be captured by a camera device as indicated in modified example 3 for setting information image data to be thereby read.

In the aforementioned exemplary embodiment, an example has been described in which setting information of the first multifunction device 200A is backed up to the cloud server 100 using the second multifunction device 200B and then transferred to the multifunction device 200C; however, it should be noted that the present disclosure is not restricted thereto, and backup and transfer processing may be executed with the multifunction devices 200A and 200B being connected to a computer terminal without using the cloud server 100.

It should be noted that, in the aforementioned exemplary embodiment, the term “processor” refers to hardware in a broad sense. Examples of a processor include general processors (e.g., CPUs: central processing units) and dedicated processors (e.g., GPUs: graphics processing units, ASICs: application integrated circuits, FPGAs: field programmable gate arrays, and programmable logic devices).

In the aforementioned exemplary embodiment, the term “processor” is broad enough to encompass one processor or plural processors in collaboration which are located physically apart from each other but may work cooperatively. Furthermore, the order of operations of the processor is not limited to one described in the aforementioned exemplary embodiment, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising a processor configured to acquire setting information from image data obtained by reading an image relating to the setting information that is output from an image forming device.

2. The information processing device according to claim 1,
wherein the information processing device is provided with an imaging device, and
the imaging device reads the image relating to the setting information that is output from the image forming device, and converts the image into the image data.

3. The information processing device according to claim 1,
wherein the information processing device is provided with a memory, and
the processor sets the acquired setting information in the memory as new setting information.

4. The information processing device according to claim 2,
wherein the information processing device is provided with a memory, and
the processor sets the acquired setting information in the memory as new setting information.

5. The information processing device according to claim 1,
wherein the processor transmits the acquired setting information to a management device that is connectable to the information processing device via a network.

6. The information processing device according to claim 2,
wherein the processor transmits the acquired setting information to a management device that is connectable to the information processing device via a network.

7. The information processing device according to claim 3,
wherein the processor transmits the acquired setting information to a management device that is connectable to the information processing device via a network.

8. The information processing device according to claim 4,
wherein the processor transmits the acquired setting information to a management device that is connectable to the information processing device via a network.

9. The information processing device according to claim 1,
wherein the processor analyzes and converts the acquired setting information into a new format.

10. The information processing device according to claim 2,
wherein the processor analyzes and converts the acquired setting information into a new format.

11. The information processing device according to claim 3,
wherein the processor analyzes and converts the acquired setting information into a new format.

12. The information processing device according to claim 4,
wherein the processor analyzes and converts the acquired setting information into a new format.

13. The information processing device according to claim 5,
wherein the processor analyzes and converts the acquired setting information into a new format.

14. The information processing device according to claim 6,
wherein the processor analyzes and converts the acquired setting information into a new format.

15. An information processing system comprising:
an image forming device;
an information processing device; and
a management device that is connectable to the information processing device via a network,
wherein the image forming device outputs setting information of the image forming device as an image,
the information processing device acquires the setting information by reading the image relating to the setting information that is output from the image forming device, and transmits the setting information to the management device, and
the management device receives the setting information.

16. The information processing system according to claim 15,
wherein the information processing device analyzes and converts the acquired setting information into a new format, and transmits the converted setting information to the management device.

17. The information processing system according to claim 15,
wherein the management device analyzes and converts the acquired setting information into a new format.

18. The information processing system according to claim 15,
wherein the management device transmits the acquired setting information or the setting information that has been converted into a new format, to another different information processing device that is connectable to the management device via the network.

19. The information processing system according to claim 16,
wherein the management device transmits the acquired setting information or the setting information that has been converted into the new format, to another different information processing device that is connectable to the management device via the network.

20. The information processing system according to claim 17,
wherein the management device transmits the acquired setting information or the setting information that has been converted into the new format, to another different information processing device that is connectable to the management device via the network.
